(19) United States
(12) Patent Application Publication
(10) Pub. No.: US 2001/0053307 A1
(43) Pub. Date: Dec. 20, 2001

(54) Handwriting instrument

(76) Inventor: Michael Rigoni, Nledereschach-Fischback (DE)

Correspondence Address: Stephan A. Pendorf, Pendorf & Cutliff, P.O. Box 20445, Tampa, FL, 33622-0445, US

(21) Appl. No.: 09/870,281

(22) Filed: May 30, 2001

(30) Foreign Application Priority Data
May 30, 2000 (DE) 200 09 728.8

(51) Int. Cl. B43K 5/02; A46B 5/02

(52) U.S. Cl. 401/222; 401/6

(57) ABSTRACT

A handwriting instrument consists of a top part (1) and a connected intermediate part (2), on the end of which a tip (3) is fastened. To make it possible to insert the intermediate part (2) into the top part (1) rapidly and securely during the assembly of the handwriting instrument, there are two detent elements (5) and two lead-in bevels (8) on the top part (1), which guide two flexible studs (4) into the detent elements (5), where the studs (4) are locked. A sleeve (11) fastened to the intermediate part (2) by means of a bayonet connection (13, 21; 12, 14, 20) covers the studs (4) and the detent elements (5). For easy handling of the writing instrument, there is a grip (18) made of non-slip but soft rubber on the intermediate part (2).

This invention relates to a handwriting instrument with a refill, the handwriting instrument consisting of an upper part, an intermediate part and a tip that can be fastened to the lower end of the intermediate part.

A swing-out stamp with a stamp pad, for example, can be integrated into handwriting instruments of this type, but it requires a relatively complicated structure of the handwriting instrument. By way of example, a handwriting instrument with an integrated stamp and stamping pad is described in DE 298 00 041.

The user of a handwriting instrument wishes to have a writing instrument that is easy to handle and sturdy, and the a manufacturer wishes to have a writing instrument that can be assembled from its individual parts easily, quickly and economically.

The objective of the invention is therefore to design a handwriting instrument so that it is sturdy and easy for the user to handle and can be assembled from its individual parts easily, quickly and economically.

The invention teaches that this objective can be accomplished by the features disclosed in the characterizing portion of claim 1, whereby at least one flexible stud located on the intermediate part is guided into a diagonal detent element of the upper part so that as a result of the rotation of the intermediate part relative to the upper part, the intermediate part can be displaced in the longitudinal direction relative to the upper part, whereby, depending on the direction of rotation, the tip of the refill is exposed or covered, and that on the lower end of the upper part there is a lead-in bevel to guide the studs when the intermediate part is inserted into the upper part.

The handwriting instrument claimed by the invention consists of an upper part, to which is connected an intermediate part, on the one end of which a tip is fastened. The tip is preferably screwed onto the intermediate part. For ease of writing, there is a grip on the intermediate part that is preferably made of a non-slip, soft rubber.

To assemble the handwriting instrument claimed by the invention, the upper end of the intermediate part with the two flexible studs is inserted into the lower end of the upper part, whereby the flexible studs are easily guided by the lead-in bevels into the detent elements, where they are locked in place. To be able to fix the intermediate part in either of the two limit positions, on each end of the detent elements there is a trough to lock the studs in place. The detent elements and the studs are covered by a sleeve that is inserted over them and they can be connected to and detached from the sleeve by means of a bayonet connector.

The interlocking of the detent elements results in a high degree of stability, while the lead-in bevels claimed by the invention significantly facilitate the assembly of the handwriting instrument claimed by the invention and simultaneously reduce the amount of time required to assemble a handwriting instrument as claimed by the invention.

By rotating the intermediate part relative to the top part, depending on the direction of rotation, the tip of a refill inserted into the handwriting instrument is either exposed or covered.

The invention is explained in greater detail below with reference to the exemplary embodiment and its individual parts which are illustrated in the accompanying figures, in which:

FIG. 1 is an overall view of one exemplary embodiment of the invention with a stamp integrated into the upper part,

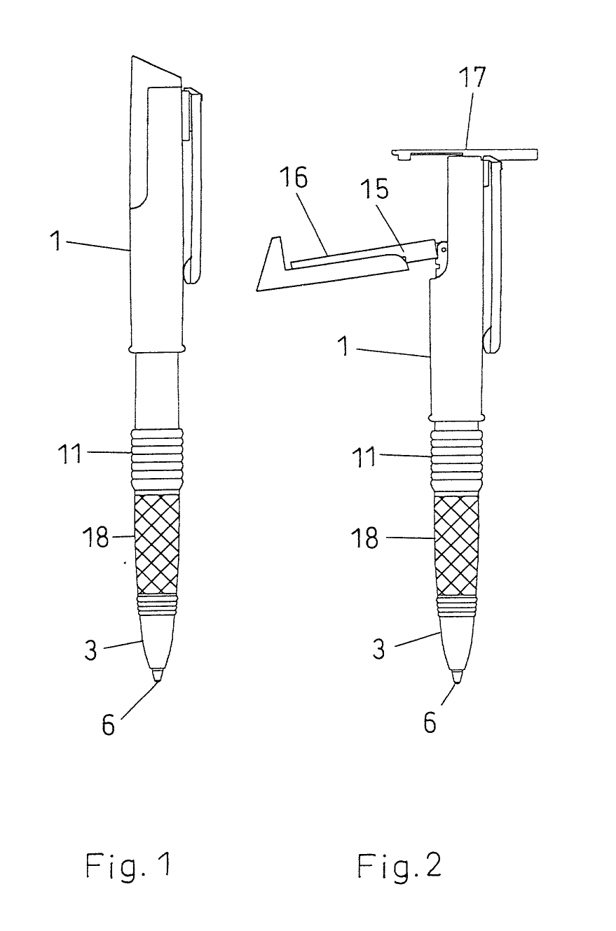

FIG. 2 is an overall view of the exemplary embodiment illustrated in FIG. 1, with the stamp folded up,

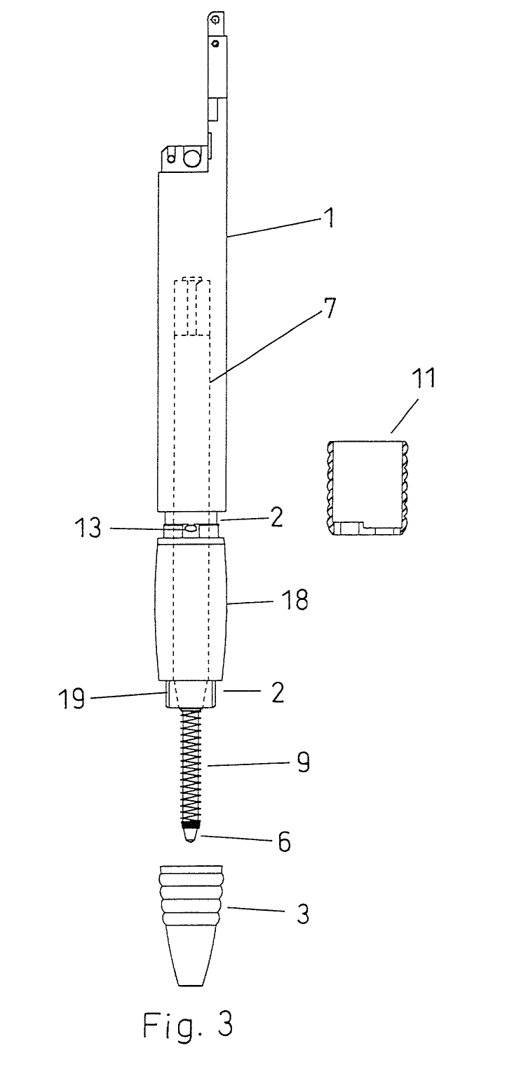

FIG. 3 is an exploded view of the exemplary embodiment without the stamp, stamp pad holder and stamp pad,

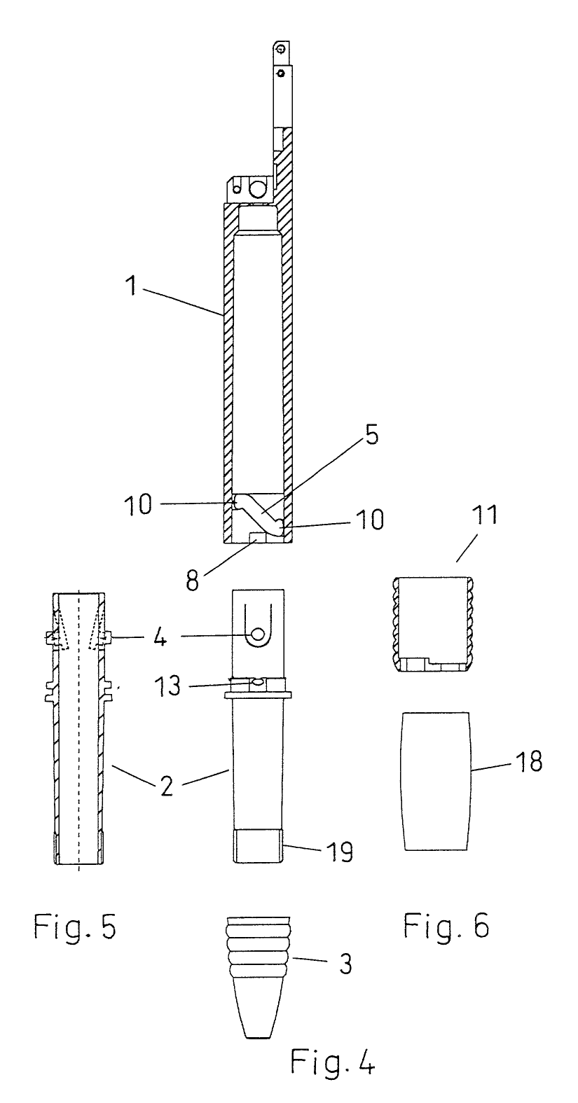

FIG. 4 is a longitudinal section through the upper part as well as a side view of the intermediate part and the tip,

FIG. 5 is a longitudinal section through the intermediate part,

FIG. 6 is a longitudinal section through the sleeve and the grip in a side view,

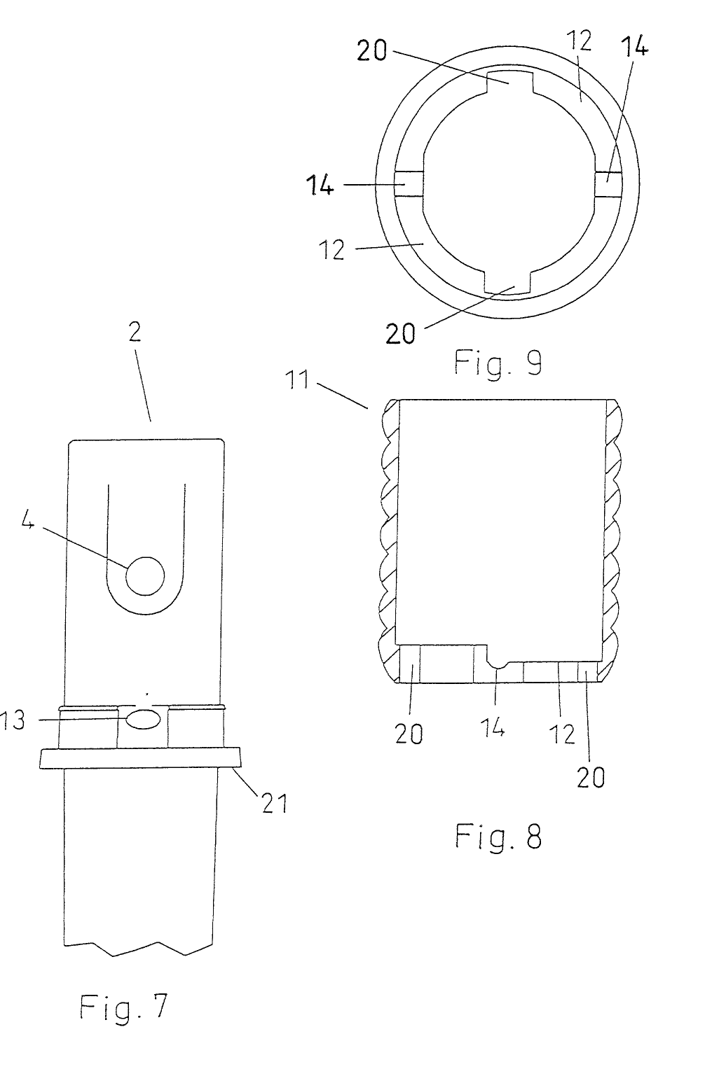

FIG. 7 shows the upper end of the intermediate part with the studs,

FIG. 8 is a longitudinal section through the sleeve, and

FIG. 9 shows the sleeve from below.

FIG. 1 is an overall view of one exemplary embodiment of a handwriting instrument as claimed by the invention.

Adjacent to the upper part 1, in which are integrated a stamp, a stamp pad holder and a stamp pad, is the intermediate part, which is not visible in FIG. 2 and onto which the tip 3 is screwed. On the intermediate part sit the sleeve 11 and the grip 18, which is preferably made from a soft, non-slip rubber. The tip 6 of the refill projects from the tip 3.

FIG. 2 shows an overall view of the exemplary embodiment illustrated in FIG. 1 with the folded-out stamp 17 and with the stamp pad holder 15 on which the stamp pad 16 lies.

FIG. 3 shows an exploded view of the exemplary embodiment illustrated in FIG. 1, but without the stamp, stamp pad holder and stamp pad.

A refill 7 with a tip 6 is inserted into the handwriting instrument. The intermediate part 2, on which two preferably oval studs 13 are located, is inserted into the upper part 1. Next to it, shown in the same relative position, the figure shows the sleeve 11, which is fastened by means of a bayonet connection, to which the studs 13 of the intermediate part 2 belong, when it has been installed on the intermediate part. Between a stop on the refill 7 and a stop in the tip 3 there is a compression spring 9 on the refill 7 which, when the instrument is assembled, holds the refill 7 in the rest position, as in conventional ball-point pens.

FIG. 4 shows, in the same relative orientation, a longitudinal section through the top part 1 and a side view of the intermediate part 2 and the tip 3.

Provided in the lower end of the upper part 1 there are two opposite detent elements 5, however, only one of which is visible in the drawing. On one end of a detent element 5 there is a trough 10 in which the flexible studs 4 of the intermediate part 2 are locked. On the lower end of the upper part 1 there are also two lead-in bevels 8 which, when the intermediate part 2 is inserted into the upper part 1, guide the flexible studs 4, which are thereby easily locked in the detent elements 5.

In the upper portion of the intermediate part 2, there are two flexible studs 4 opposite each other. Underneath them are located two preferably oval studs 13. Only one of the studs 4 and one of the studs 13 are visible in FIG. 4. On the lower end of the intermediate part 2, a male thread 19 is provided, onto which the tip 3 is screwed.

In addition to FIG. 4, FIG. 5 shows, in the same relative orientation, a longitudinal section through the intermediate part 2.

This longitudinal section shows the studs 4 in the removed or integrated position, and in dotted lines during the insertion into the lead-in bevels 8.

In addition to FIG. 4, FIG. 6 also shows, in the same relative orientation, the sleeve 11, including the grip 18 in the same relative orientation.

FIG. 7 shows the upper end of the intermediate part 2.

The two flexible studs 4 on the intermediate part 2 are located opposite each other. Located below the two studs 4 are the two likewise opposite studs 13, which preferably have an oval shape. Next to FIG. 7, FIG. 8 shows the sleeve 11 in longitudinal section, and on the lower end of the sleeve 11 are two grooves 12, two troughs 14 and two guide openings 20. The sleeve 11 is inserted on the upper end of the intermediate part 2, so that the studs 13 of the intermediate part 2 slide through the two guide openings 20. When the sleeve 11 is rotated, the studs 13 slide in the grooves 12 until they catch in the troughs 14. As an abutment there is a flange 21 attached to the intermediate part 2, against which flange the lower end of the sleeve 11 is pressed by the studs 13.

FIG. 9 shows the sleeve 11 from below.

Provided into the lower edge of the sleeve 11 are the two opposite troughs 14 and the two opposite guide openings 20. A trough 14 and a guide opening 20 are offset from each other by an angle of 90°.

The handwriting instrument claimed by the invention is characterized on one hand by a stable and sturdy structure, and on the other hand can be assembled quickly and economically from a small number of individual parts. It is suitable in particular for ball-point pens—with and without the integrated stamp. However, instead of a ball-point pen with refill cartridge, the invention can be used with a felt pen with refill cartridge, a mechanical pencil with refill lead, or another type of refill cartridge can also be used.

Rerence Number List

1 Top part

2 Intermediate part

3 Tip

4 Flexible studs

5 Detent element

6 Tip of a refill

7 Refill

8 Lead-in bevel

9 Compression spring

10 Trough

11 Sleeve

12 Groove

13 Studs

14 Trough

15 Stamp pad holder

16 Stamp pad

17 Stamp

18 Grip

19 Male thread

20 Guide opening

21 Flange

1. Handwriting instrument with a refill consisting of a top part (1), an intermediate part (2) and a tip (3) that can be fastened to the lower end of the intermediate part (2), characterized by the fact that at least one flexible stud (4) located on the intermediate part (2) is guided in a diagonal detent element (5) of the top part (1) so that the intermediate part (2) can be displaced in the longitudinal direction relative to the top part (1) by rotating the intermediate part (2) relative to the top part (1), whereby depending on the direction of rotation, the tip (6) of the refill (7) is exposed or covered, and that on the lower end of the top part (1) there is an lead-in bevel (8) to guide the studs (4) during insertion of the intermediate part (2) into the top part (1).

2. Handwriting instrument as claimed in claim 1, characterized by the fact that a compression spring (9) is located between a stop on the tip (3) and the refill (7), and that a trough (10) to lock the studs (4) is worked into each end of the detent elements (5).

3. Handwriting instrument as claimed in claims 1 or 2, characterized by the fact that a sleeve (11) that covers the studs (4) and the detent elements (5) is fastened to the intermediate part (2).

4. Handwriting instrument as claimed in claim 3, characterized by the fact that the sleeve (11) is fastened to the intermediate part (2) by means of a bayonet connection (13, 21; 12, 14, 20).

5. Handwriting instrument as claimed in claim 4, characterized by the fact that two grooves (12) are worked into the sleeve (11) to guide two studs (13) located on the intermediate part (2), and troughs (14) are worked into the end of the grooves (12) to lock the studs (13).

6. Handwriting instrument as claimed in one of the claims 1 to 5, characterized by the fact that a grip (18) made of rubber sits on the intermediate part (2).

7. Handwriting instrument as claimed in one of the claims 1 to 6, characterized by the fact that in the top part (1) are incorporated a stamp (17) and a stamp pad holder (15) with an inserted stamp pad (16), which can be pivoted from the rest position into the stamping position and back into the rest position.
